(19) United States
(12) Patent Application Publication
(10) Pub. No.: US 2013/0192512 A1
(43) Pub. Date: Aug. 1, 2013

(54) SAFETY GAUGE TO PREVENT SLING USERS FROM EXCEEDING A SAFE WORKING LOAD OF A SLING

(71) Applicant: Mark Conrad Erickson, Ellabell, GA (US)

(72) Inventor: Mark Conrad Erickson, Ellabell, GA (US)

(21) Appl. No.: 13/752,275

(22) Filed: Jan. 28, 2013

Related U.S. Application Data
(60) Provisional application No. 61/591,586, filed on Jan. 27, 2012.

(51) Int. Cl. G01D 7/00

(52) U.S. Cl. CPC G01D 7/005
USPC 116/201; 116/212

(57) ABSTRACT

A safety gauge prevents sling users from exceeding the safe working load of a sling. Unlike conventional devices, the safety gauge described herein has no interference from internal yarns and can be preset to a prescribed load. A strand of yarn (indicator yarn) can be disposed between inner and outer jackets of the sling, in a choke configuration, and attached to an indicator. The outer jacket is then closed in the traditional manner and a window tag in the outer layer is strategically placed over the indicator to permit a user to view the indicator during use of the sling. When pressure is applied, the indicator yarn begins to move in direct relation to the load being applied, causing the indicator to move in the window tag. At a predetermined point, a red color shows, alerting the user that they are in danger of an overload.

### CROSS-REFERENCE TO RELATED APPLICATION

This application claims the benefit of priority of U.S. provisional application number 61/591,586, filed Jan. 27, 2012, the contents of which are herein incorporated by reference.

### BACKGROUND OF THE INVENTION

The present invention relates to safety devices and, more particularly, to a safety gauge to prevent sling users from exceeding a safe working load of a sling.

Often, sling users do not know the exact load weight and are at risk of overload. Without having an indicator as to if they are over the safe working load of the sling, overload can occur, which can lead to injury or death.

Conventional load weight devices have interference from internal yarns, causing unreliable results. Some conventional devices can be easily tampered with, making for unreliable output.

As can be seen, there is a need for an improved safety gauge to prevent sling users from exceeding a safe working load of a sling.

### SUMMARY OF THE INVENTION

In one aspect of the present invention, a safety gauge for a sling, comprises a tag yarn disposed between an outer layer and an inner layer of the sling; a ring formed in a first end of the tag yarn, a second end of the tag yarn extending through the ring and attached to an indicator; and an outer cover tag window disposed in the outer layer, wherein the indicator is viewable through the outer cover tag window such that a white color region of the indicator is viewable when no force is applied to the sling and a red color region of the indicator is viewable as the force applied to the sling approaches a working load limit of the sling.

In another aspect of the present invention, a safety gauge for a sling, comprises an inner layer of the sling; internal yarn disposed within the inner layer of the sling; a tag yarn disposed between an outer layer of the sling and the inner layer, the tag yarn formed from at least one strand of the internal yarn; a ring formed in a first end of the tag yarn, a second end of the tag yarn extending through the ring and attached to an indicator; and an outer cover tag window disposed in the outer layer, wherein the indicator is viewable through the outer cover tag window such that a white color region of the indicator is viewable when no force is applied to the sling and a red color region of the indicator is viewable as the force applied to the sling approaches a working load limit of the sling.

In a further aspect of the present invention, a method for preventing a user from exceeding a working load limit of a sling comprises disposing a tag yarn between an inner layer and an outer layer of a sling, a first end of the tag yarn formed in a ring and the second end of the tag yarn passing through the ring and attached to an indicator viewable through a window formed in the outer layer; and discontinuing use of the sling when a red color region of the indicator is visible in the window.

These and other features, aspects and advantages of the present invention will become better understood with reference to the following drawings, description and claims.

### BRIEF DESCRIPTION OF THE DRAWINGS

FIG. 1 is a perspective view of a sling having a safety gauge according to an exemplary embodiment of the present invention;

FIG. 2 is a detailed front view of the safety gauge of FIG. 1;

FIG. 3 is a cross-sectional view taken along line 3-3 of FIG. 1;

FIG. 4 is a partially cut-away perspective view of the sling with the safety gauge of FIG. 1, in a relaxed state;

FIG. 5 is a perspective view of a polymer color indicator tag of the safety gauge of FIG. 1;

FIG. 6 is a cross sectional view taken along line 6-6 of FIG. 2;

FIG. 7 is a perspective view of the sling of FIG. 1, shown in a force-applied state;

FIG. 8 is a detailed front view of the safety gauge of FIG. 7, shown in a force-applied state;

FIG. 9 is a cross-sectional view taken along line 9-9 of FIG. 7; and

FIG. 10 is a partially cut-away perspective view of the sling with the safety gauge of FIG. 7, in a force-applied state.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a safety gauge that can prevent sling users from exceeding the safe working load of a sling. Unlike conventional devices, the safety gauge described herein has no interference from internal yarns and can be preset to a prescribed load. A strand of yarn (indicator yarn) can be disposed between inner and outer jackets of the sling, in a choke configuration, and attached to an indicator. The outer jacket is then closed in the traditional manner and a window tag in the outer layer is strategically placed over the indicator to permit a user to view the indicator during use of the sling. When pressure is applied, the indicator yarn begins to move in direct relation to the load being applied, causing the indicator to move in the window tag. At a predetermined point, a red color shows, alerting the user that they are in danger of an overload.

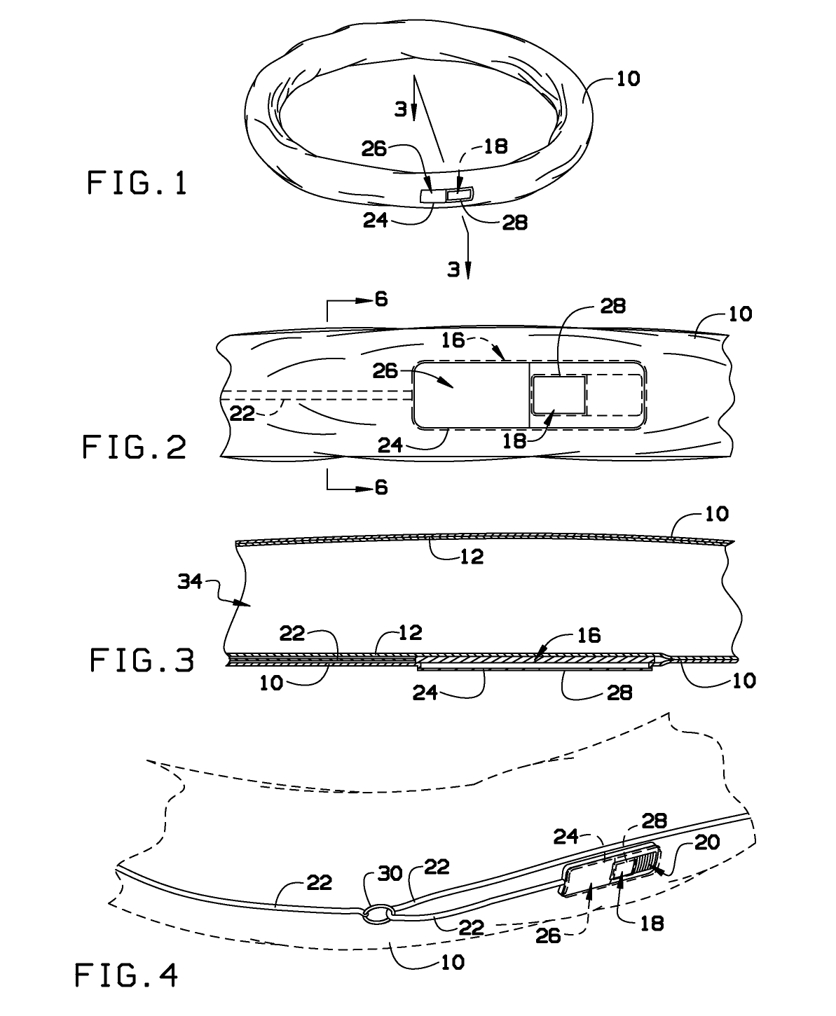

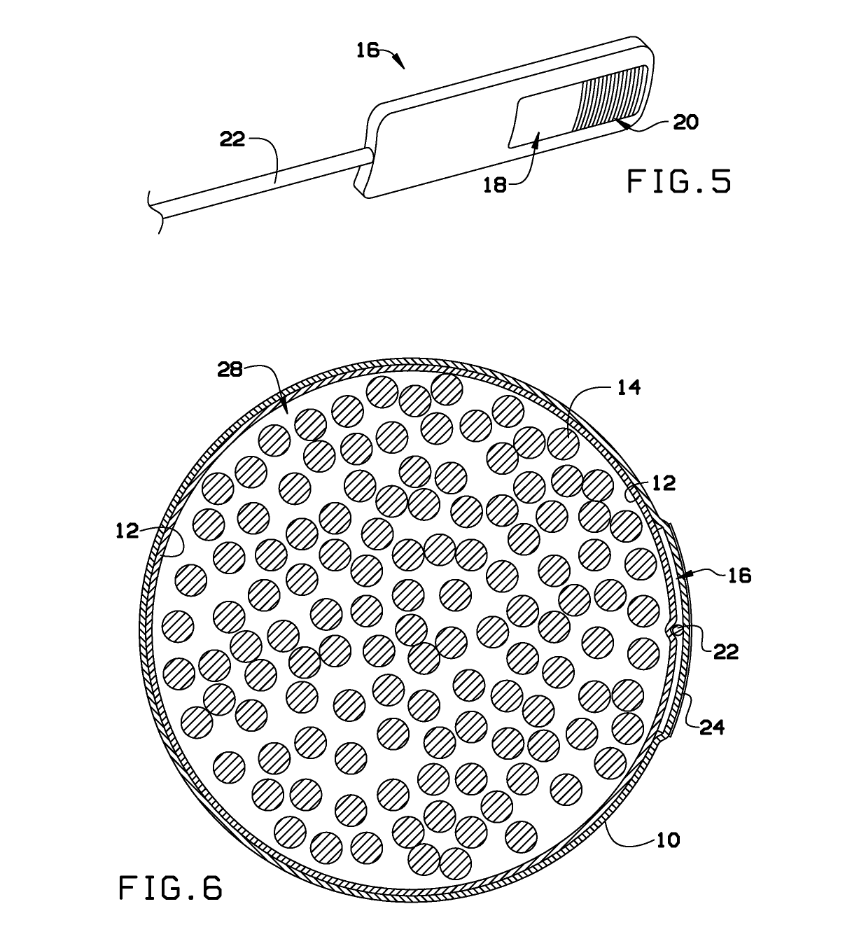

Referring now to FIGS. 1 through 10, a sling can have an inner cover 12 and an outer cover 10 encasing internal yarn 14 disposed within an internal yarn cavity 34. An indicator 16 can be disposed to be viewable through an outer cover tag window 28 formed in an outer cover tag 24 of the outer cover 10. An outer cover tag information print region 26 can be disposed on the outer cover tag 24. This region 26 can provide information about the sling, its load limits, and the like.

The indicator 16 can be, for example, a polymeric color indicator tag having a white color region 18 and a red color region 20 viewable through the outer cover tag window 28.

A tag yarn 22 can extend about the sling, between the inner cover 12 and the outer cover 10. The tag yarn 22 can be, for example, made of the same material as the internal yarn 14. The tag yarn 22 can pass from a first end formed in a ring 30, around the sling, back through the ring 30 to turn the tag yarn 22 back about 180 degrees to attach to the indicator 16. The tag yarn 22 can be, for example, a polyester or a high performance aramid fiber.

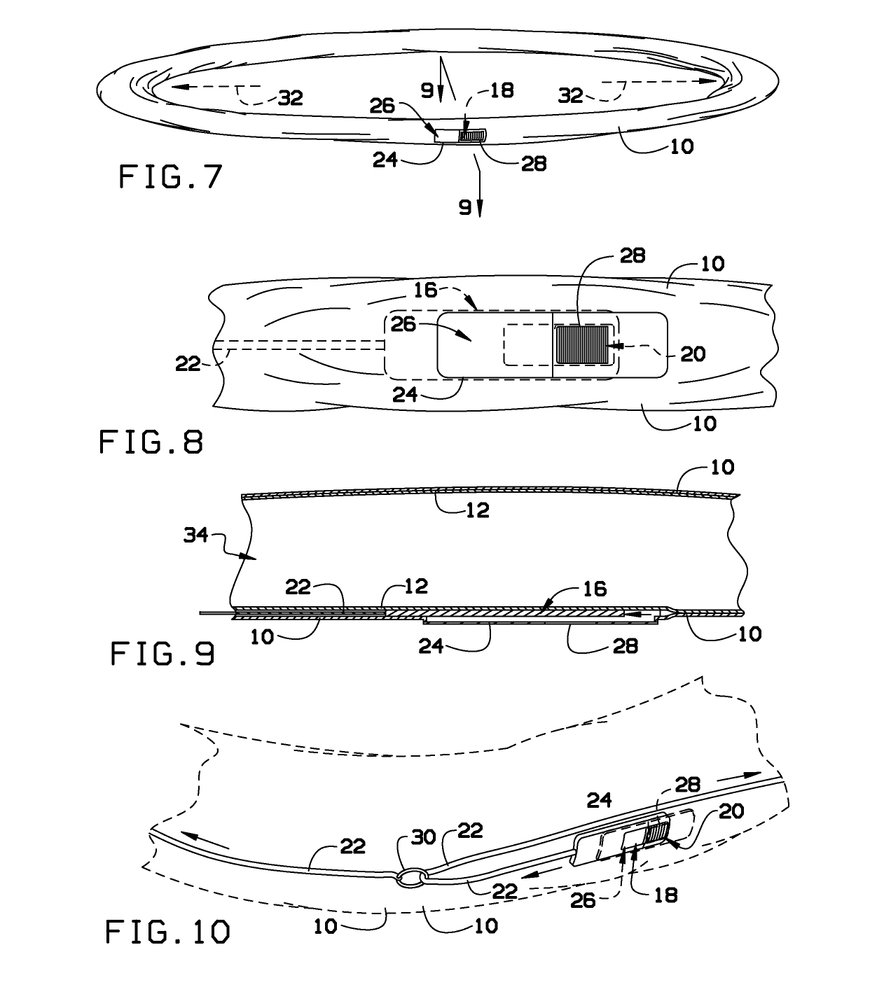

When a force is applied (indicated, for example, by arrows 32 in FIG. 7), the indicator 16 can show more of the red color region 20, indicating that the user is approaching a load limit of the sling.

The indicator 16 is disposed into the sling so as to eliminate any misuse on the end user. The end user simply uses the sling in the traditional manner and the warning indicator is self-evident during use. The warning indicator can be designed to indicate various load limits. For example, the warning indicator can be designed to show an entire red color through the window at a load of 4,000 pounds. Of course, other weight load limits can be designed.

It should be understood, of course, that the foregoing relates to exemplary embodiments of the invention and that modifications may be made without departing from the spirit and scope of the invention as set forth in the following claims.

What is claimed is:

1. A safety gauge for a sling, comprising:
a tag yarn disposed between an outer layer and an inner layer of the sling;
a ring formed in a first end of the tag yarn, a second end of the tag yarn extending through the ring and attached to an indicator; and
an outer cover tag window disposed in the outer layer, wherein
the indicator is viewable through the outer cover tag window such that a white color region of the indicator is viewable when no force is applied to the sling and a red color region of the indicator is viewable as the force applied to the sling approaches a working load limit of the sling.

2. The safety gauge of claim 1, wherein the tag yarn is formed from a single strand of the material used for internal yarn of the sling.

3. The safety gauge of claim 1, wherein the indicator is a polymeric indicator tag.

4. The safety gauge of claim 1, further comprising an outer cover tag comprising an outer cover tag print region and the outer cover tag window.

5. A safety gauge for a sling, comprising:
an inner layer of the sling;
internal yarn disposed within the inner layer of the sling;
a tag yarn disposed between an outer layer of the sling and the inner layer, the tag yarn formed from at least one strand of the internal yarn;
a ring formed in a first end of the tag yarn, a second end of the tag yarn extending through the ring and attached to an indicator; and
an outer cover tag window disposed in the outer layer, wherein
the indicator is viewable through the outer cover tag window such that a white color region of the indicator is viewable when no force is applied to the sling and a red color region of the indicator is viewable as the force applied to the sling approaches a working load limit of the sling.

6. The safety gauge of claim 5, wherein the indicator is a polymeric indicator tag.

7. The safety gauge of claim 5, further comprising an outer cover tag comprising an outer cover tag print region and the outer cover tag window.

8. A method for preventing a user from exceeding a working load limit of a sling, the method comprising:
disposing a tag yarn between an inner layer and an outer layer of a sling, a first end of the tag yarn formed in a ring and the second end of the tag yarn passing through the ring and attached to an indicator viewable through a window formed in the outer layer; and
discontinuing use of the sling when a red color region of the indicator is visible in the window.

9. The method of claim 8, wherein the tag yarn is formed from a single strand of the material used for internal yarn of the sling.

10. The method of claim 8, further comprising providing sling instructions on an outer cover tag print region of the sling.
